(19) United States
(12) Patent Application Publication
(10) Pub. No.: US 2012/0168060 A1
(43) Pub. Date: Jul. 5, 2012

(54) TIRE MANDREL

(76) Inventor: Joseph Carmine Lettieri, Hudson, OH (US)

(21) Appl. No.: 13/095,985

(22) Filed: Apr. 28, 2011

Related U.S. Application Data
(60) Provisional application No. 61/428,930, filed on Dec. 31, 2010.

(51) Int. Cl. B29D 30/08; B29D 30/38; B60C 9/14

(52) U.S. Cl. 156/123; 156/394.1

(57) ABSTRACT

A mandrel for building a tire is described having a torus shape. The mandrel is formed of a first annular layer for forming the outer tread surface of a tire. The first annular layer of material has outer ends joined to a second and third layer of material for forming the sidewalls. The first annular layer is formed of a woven material reinforced with circumferential cords, and the second and third layer of material is formed of a woven material having reinforcement cords arranged in concentric circles. The second and third layer of material has a radially inner end received in a clamp of a mandrel support device which includes means for inflating the tire mandrel.

### CROSS REFERENCE TO OTHER APPLICATIONS

This application claims the benefit of and incorporates by reference U.S. Provisional Application No. 61/428,930, filed Dec. 31, 2010.

### FIELD OF THE INVENTION

The invention relates to the field of manufacturing, and more particularly to tire manufacturing.

### BACKGROUND OF THE INVENTION

Tires are typically built in multiple layers of rubber layed up onto a cylindrical tire building drum. The carcass is formed from applying multiple tire components onto the tire building drum such as the inner liner, one or more layers of ply, the sidewalls, chafer apex and bead subassemblies. The carcass is then typically expanded into a toroid shape and the tread and belt package are applied. It is beneficial to build a tire in its final shape using a toroid building form or mandrel. One road block to building a tire upon a torus shaped mandrel is that it is extremely difficult to remove the mandrel from the tire. Thus it is desired to have an improved method and apparatus for building a tire without the difficulty in removing the mandrel.

### DEFINITIONS

“Aspect Ratio” means the ratio of a tire's section height to its section width.

“Axial” and “axially” mean the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

### BRIEF DESCRIPTION OF THE DRAWINGS

The invention will be described by way of example and with reference to the accompanying drawings in which:

FIG. 1 is a perspective view of a tire mandrel of the present invention;

FIG. 2 is a side view of the tire mandrel of FIG. 1 shown being assembled;

FIG. 3 is a side view of the tire mandrel shown in the assembled and expanded position;

FIG. 4 is a is cross-sectional view of the tire mandrel shown with a layer of ply;

FIG. 5 is a is cross-sectional view of the tire mandrel shown with a layer of ply, sidewall and bead;

FIG. 6 is a cross-sectional view of the tire mandrel shown with the carcass being removed from the mandrel support;

FIG. 7 is a cross-sectional view of the tire mandrel shown with the carcass having a tread being removed form the mandrel support;

FIG. 8 is a cross-sectional view of the tire mandrel shown with the carcass having a tread being removed form the mandrel support with the mandrel end being folded over the bead; and

FIG. 9 is a cross-sectional view of the tire shown with the mandrel formed as part of the tire and located within the interior of the tire.

### DETAILED DESCRIPTION OF THE INVENTION

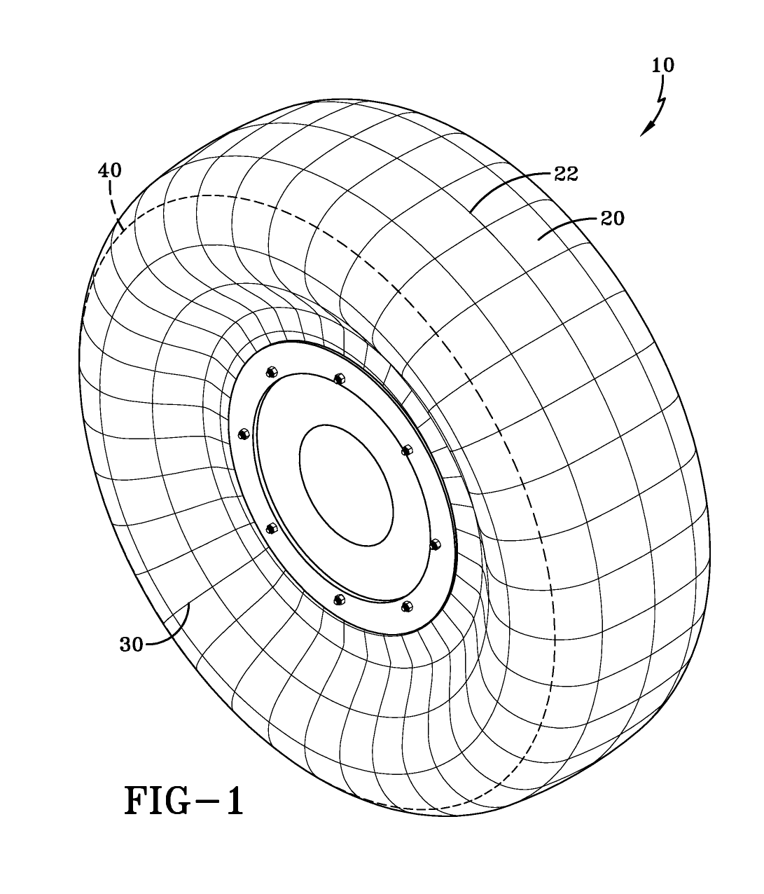

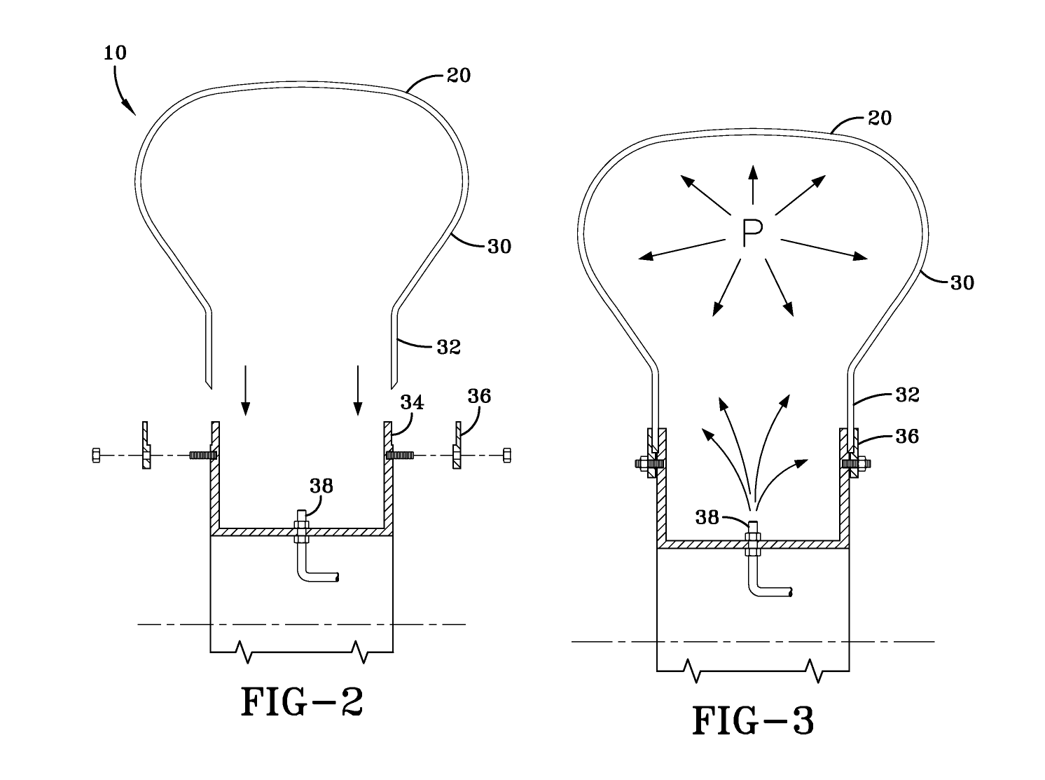

FIG. 1 illustrates a mandrel 10 useful for providing a building surface for building a tire or tire component. The mandrel 10 is preferably torus shaped having an outer dimension to match the internal shape of a tire. Preferably, the mandrel is formed of a first layer of material forming an outer circumferential annular layer 20. The first layer 20 has a plurality of cords 22 oriented parallel to the circumferential direction. More preferably, the first layer 20 has cords oriented in both the circumferential direction and the radial direction. The mandrel 10 further comprises a first and second sidewall layer 30. The first and second sidewall layer 30 each have reinforcement cords oriented in both the radial direction and the circumferential direction. The circumferential cords are arranged in concentric circles having increasing diameters. The densities of the circles control the cross-sectional shape of the mandrel. Each of the first and second sidewall layers have a radially inner end 32 which is clamped to a mandrel support frame 34 via clamp 36 as shown in FIG. 2. The mandrel support frame has an inlet 38 for providing pneumatic fluid to expand the mandrel into its final torus shape, as shown in FIG. 3. The first and second sidewalls comprise a radially outer end 40 which are joined to the outer ends of the first layer.

The mandrel 10 may be formed of woven fabric such as nylon or polyester, reinforced with cords. More preferably, the fabric is coated with an air impermeable coating such as polyurethane or silicone. The cords may be formed of polyester, nylon, aramid or a hybrid thereof. The mandrel may also be formed of an air impermeable layer such as butyl rubber reinforced with cords as described above.

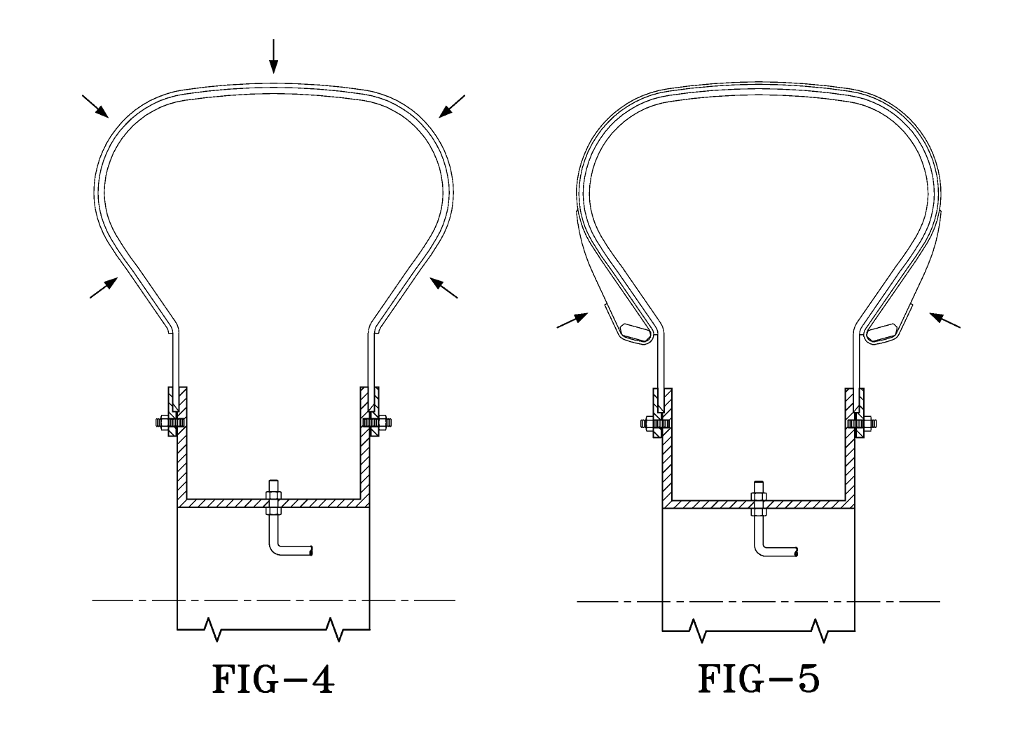

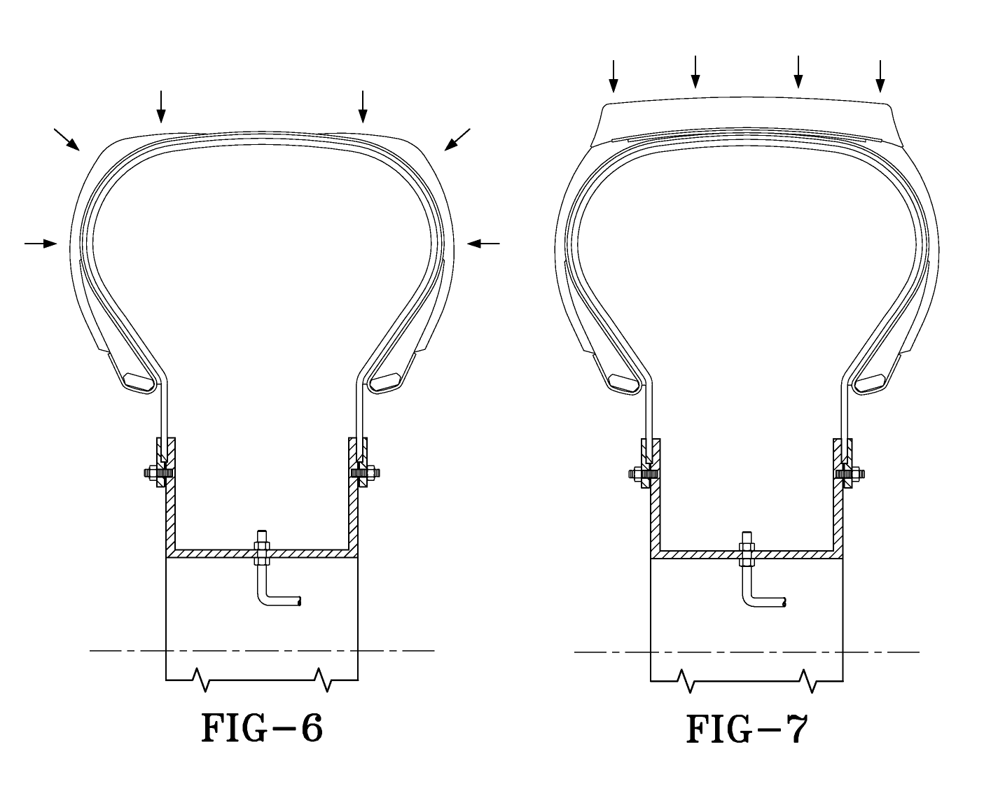

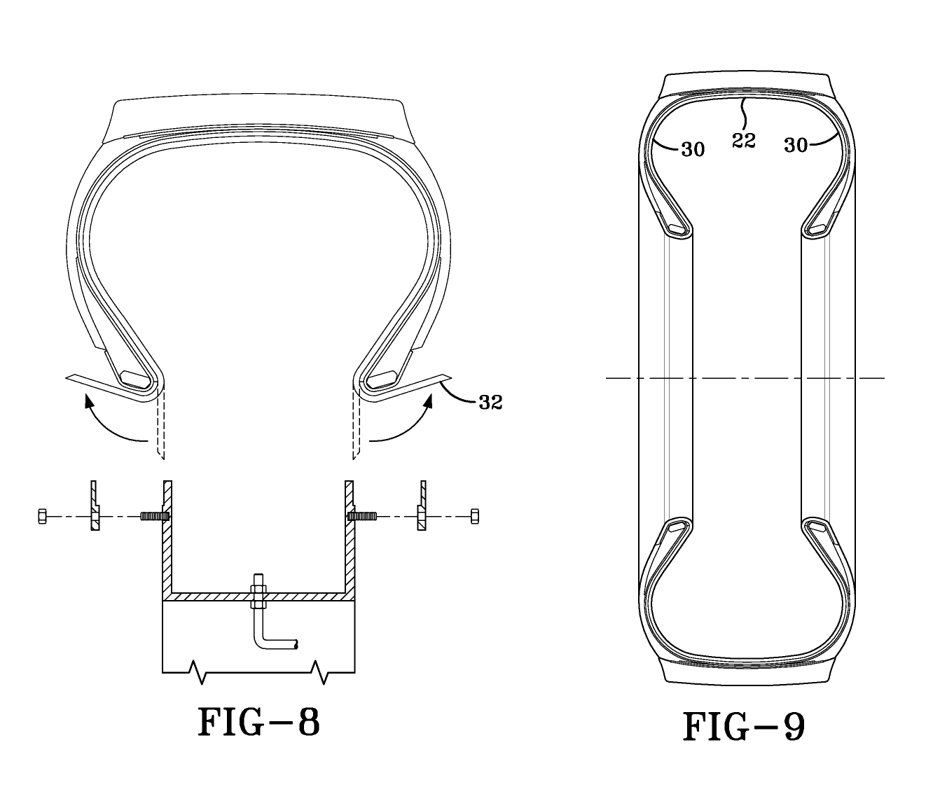

After the mandrel 10 has been expanded into its torus shape, one or more tire components may be applied such as the ply, apex, sidewall, bead and tread, as shown in FIGS. 4 through 7. After the tire components have been applied to the mandrel 10, the clamp 36 may be released and the carcass assembly may be removed from the mandrel support. The end 32 of the sidewall layer may be trimmed or wrapped around the bead as shown in FIG. 8. FIG. 7 illustrates a green tire carcass formed on the mandrel 10 wherein the mandrel forms the inner surface of the tire carcass, and is preferably not removed. The green tire carcass may then be cured in a conventional mold.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire mandrel for building a tire comprising a torus shape formed of a first annular layer for forming the outer tread surface of a tire, said first annular layer of material having outer ends joined to a second and third layer of material for forming the sidewalls, the first annular layer being formed of a woven material reinforced with circumferential cords, the second and third layer of material being formed of a woven material having reinforcement cords arranged in concentric circles, wherein the second and third layer of material has a radially inner end received in a clamp of a mandrel support device, said mandrel support device comprising means for inflating the tire mandrel.

2. The tire mandrel of claim 1 wherein the second and third layer has cords oriented in the radial direction.

3. The tire mandrel of claim 1 wherein the first second and third layer is comprised of an air impermeable material.

4. A method of forming a tire comprising the steps of:
Providing a first annular layer of material having one or more cords arranged in a circumferential direction, joining a second and third layer of material to the outer ends of the first annular layer; wherein the second and third layer has reinforcement cords arranged in concentric circles of increasing diameters, said second and third layers having an inner radial end, clamping the inner radial ends to a support, and inflating the first, second and third layers of material into a mandrel, laying a first layer of ply, a bead assembly and sidewalls onto said mandrel forming a tire carcass.

5. The method of claim 4 wherein the second and third layer has reinforcement cords arranged in a radial direction.

6. The method of claim 4 wherein the first, second and third layer is formed of a woven material.

7. The method of claim 4 wherein the first, second and third layer is formed of a nylon material.

8. The method of claim 4 wherein the first, second and third layer is formed of a polyester material.

9. The method of claim 4 wherein the first, second and third layer is formed of an air impermeable material.
